(19) United States
(12) Patent Application Publication
(10) Pub. No.: US 2026/0008242 A1
(43) Pub. Date: Jan. 8, 2026

(54) METHOD OF FORMING ASSEMBLY

(71) Applicant: TOYOTA JIDOSHA KABUSHIKI KAISHA, Toyota-shi (JP)

(72) Inventor: Akihiro TERASAKA, Toyota-shi (JP)

(73) Assignee: TOYOTA JIDOSHA KABUSHIKI KAISHA, Toyota-shi (JP)

(21) Appl. No.: 19/041,317

(22) Filed: Jan. 30, 2025

(30) Foreign Application Priority Data
Jul. 4, 2024 (JP) 2024-108095

(51) Int. Cl. B29C 70/44; B29C 33/54; B29C 65/70

(52) U.S. Cl. CPC B29C 70/44; B29C 33/54; B29C 65/70

(57) ABSTRACT

A method of forming an assembly includes an assembly step of assembling an intermediate assembly in which a core covered with a bag material is installed, a bag step of covering a mold in which the intermediate assembly is installed together with a core covered with a bag material with a bag material, a step of heating the intermediate assembly 2 after the atmospheric pressure of the outside of the bag material and the inside of the bag material is lower than the atmospheric pressure of the outside of the bag material and the atmospheric pressure of the inside of the bag material, and after the heating step, after removing the bag material from the mold, removing the core from the inside of the assembly formed by heating the intermediate assembly together with the bag material, and demolding the assembly, wherein the core is heat shrinkable or crushable.

### CROSS-REFERENCE TO RELATED APPLICATION

This application claims priority to Japanese Patent Application No. 2024-108095 filed on Jul. 4, 2024. The disclosure of the above-identified application, including the specification, drawings, and claims, is incorporated by reference herein in its entirety.

### BACKGROUND

### 1. Technical Field

The present disclosure relates to a method of forming an assembly.

### 2. Description of Related Art

Japanese Unexamined Patent Application Publication No. 2018-83326 A (JP 2018-83326 A) discloses a method of forming a composite material using a bladder bag as a mold for forming the inside of the composite material.

The composite material described in JP 2018-83326 A has a narrow portion formed by narrowing a part of the inside, and a space portion formed adjacent to the narrow portion. The method of forming a composite material includes disposing a bladder bag as a mold inside a composite material, forming the composite material, and taking out the bladder bag. The bladder bag includes a bladder bag body and a cord-like member. The bladder bag body includes a narrow forming portion that forms the narrow portion of the composite material, a space forming portion that forms the space portion of the composite material, and an air introduction port that introduces air. The cord-like member is provided inside the bladder bag body, and is connected to the inner surface of the space forming portion through the narrow forming portion from the air introduction port. In the forming, the composite material is formed while pressurizing the inside of the composite material by introducing air from the air introduction port of the bladder bag body of the bladder bag disposed in the disposing. In the taking out, the bladder bag is taken out from the inside of the composite material by pulling the cord-like member from the side of the air introduction port after the forming.

### SUMMARY

However, the bladder bag is stretchable, and therefore its shape is not stable. Therefore, when the composite material is an assembly of a plurality of parts, it is difficult to use the bladder bag to position the parts in the process of forming the assembly. In addition, when a bridge is formed in the bladder bag inserted into the assembly during the process of forming the assembly, the bladder bag may rupture when pressurizing the inside of the bladder bag, for example. In this case, a sufficient pressure for forming the assembly may not be applied to the assembly during forming, and the resulting formed article may become a waste product. Further, when the mold is removed from the assembly, the expensive bladder bag may be damaged in the process of taking out the bladder bag from the inside of the assembly. In this manner, with the technique described in JP 2018-83326 A, there is an issue that it is difficult to obtain a high-quality assembly inexpensively and stably, since a bladder bag is used.

The present disclosure has been made to address such an issue, and an object thereof is to provide a method of forming an assembly, the method providing a high-quality assembly inexpensively and stably.

An aspect provides a method of forming an assembly, the method including: assembling a hollow intermediate assembly having a core covered with a first bag material installed inside the intermediate assembly; covering a mold, in which the intermediate assembly is installed together with the core covered with the first bag material, with a second bag material; heating the intermediate assembly after an air pressure outside the first bag material and inside the second bag material is made lower than an air pressure outside the second bag material and an air pressure inside the first bag material; and demolding the assembly by removing the second bag material from the mold after the heating, and thereafter removing the core together with the first bag material from inside the assembly formed by heating the intermediate assembly, in which the core is heat-shrinkable or crushable.

According to the present disclosure, it is possible to provide a method of forming an assembly, the method providing a high-quality assembly inexpensively and stably.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an external perspective view of an assembly;

FIG. 2 is a schematic cross-sectional view for explaining a method of forming an assembly according to first embodiment;

FIG. 3 is a schematic cross-sectional view for explaining a method of forming an assembly according to second embodiment;

FIG. 4 is a schematic cross-sectional view for explaining a process for forming an assembly according to Comparative Example 1; and

FIG. 5 is a schematic cross-sectional view for explaining a method of forming an assembly according to Comparative Example 2.

### DETAILED DESCRIPTION OF EMBODIMENTS

Hereinafter, specific embodiments to which the present disclosure is applied will be described in detail with reference to the drawings. However, the present disclosure is not limited to the following embodiments. Further, for clarity of explanation, the following description and the drawings are simplified as appropriate.

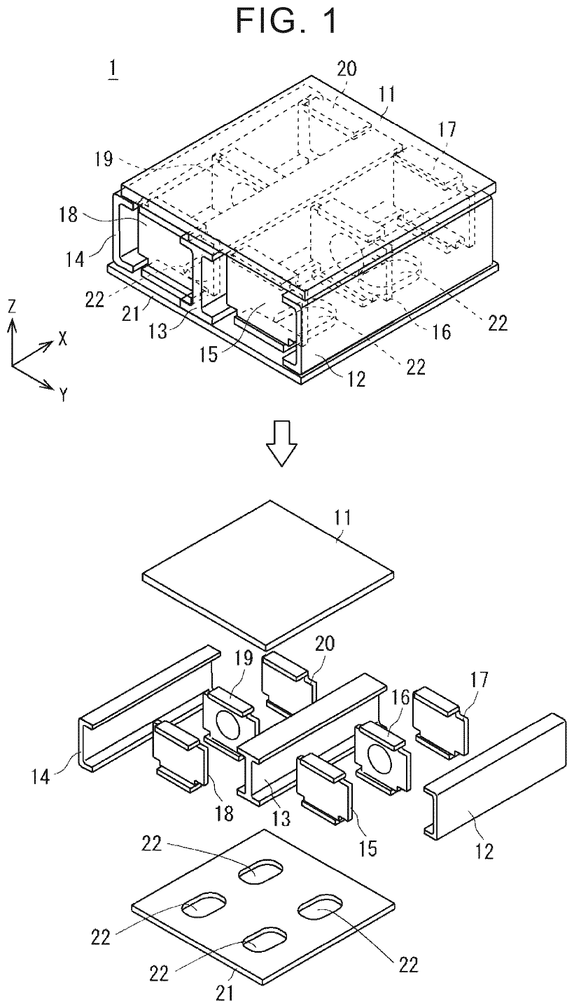

First, FIG. 1 is an external perspective view of an assembly. On the upper side of FIG. 1, an assembly 1 is shown. The underside of FIG. 1 shows an exploded perspective view of the assembly 1. The right-hand system XYZ coordinates illustrated in FIG. 1 are for convenience of describing the positional relation of the constituent elements. Usually, the Z-axis plus direction is vertically upward, and XY plane is a horizontal plane.

As shown in FIG. 1, the assembly 1 is formed by joining the components 11, 21 with the components 12, 13, 14, 15, 16, 17, 18, 19, 20 sandwiched between the components 11, 21. The components 11, 21 extend along XY plane. The components 11 and 21 are arranged to face each other in the Z direction. The components 12, 13, 14 extend along XZ plane. The components 12, 13, 14 are spaced apart in the Y direction so that the component 13 is disposed between the components 12, 14 facing each other in the Y direction. The components 15, 16, 17, 18, 19, 20 extend in YZ planes. The components 15, 16, 17 arranged between the components 12, 13 are spaced apart in the X direction so that the parts 16 are arranged between the components 15, 17 facing each other in the X direction. The parts 18, 19, 20 arranged between the components 13, 14 are spaced apart in the X direction so that the parts 19 are arranged between the parts 18, 20 facing each other in the X direction.

The assembly 1 has a hollow part surrounded by the components 11, 12, 13, 15, 16, 21, a hollow part surrounded by the components 11, 12, 13, 16, 17, 21, a hollow part surrounded by the components 11, 13, 14, 18, 19, 21, and four hollow parts surrounded by the components 11, 13, 14, 19, 20, 21. Furthermore, the assembly 1 has four through-holes 22 formed in the component 21. The component 21 is formed with a number of through holes 22 corresponding to the number of hollow portions of the assembly 1. Each of the through holes 22 is disposed so as to correspond to each of the hollow portions, and penetrates the component 21 in the Z direction.

The assembly 1 can be used, for example, as a vehicle body frame of a vehicle having a monocoque structure, an exterior part of the vehicle (for example, a rear spoiler), a blade of a wind turbine, a part installed for reinforcement in a propeller of an airplane, or the like.

### First Embodiment

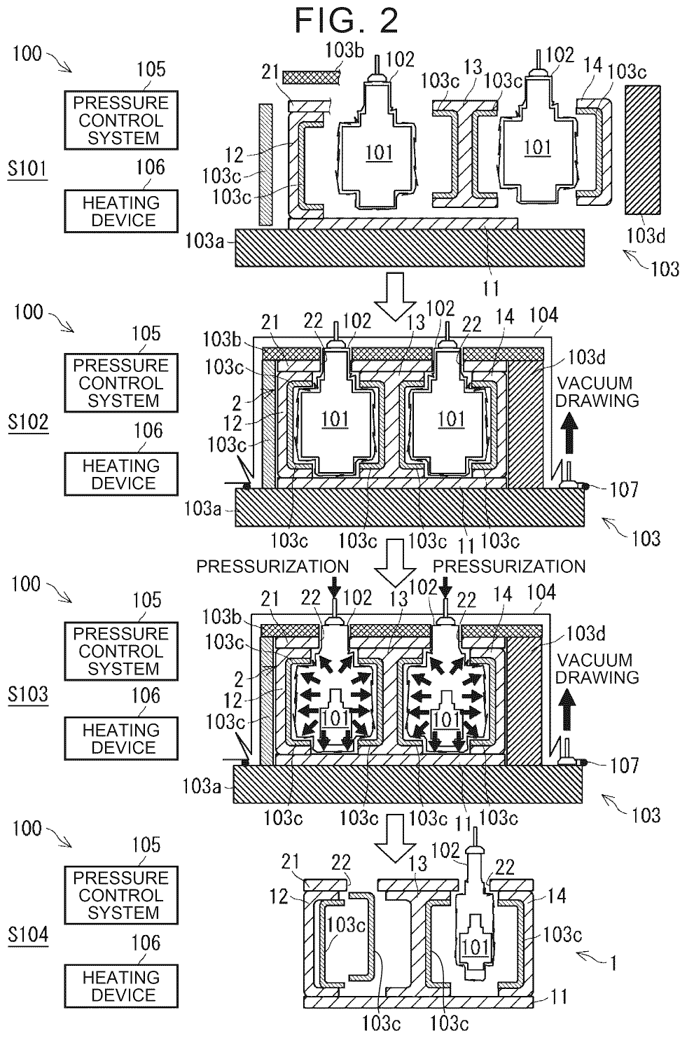

FIG. 2 is a schematic cross-sectional view for explaining a method of forming an assembly according to first embodiment. FIG. 2 shows a cross-section of a component 11, 12, 13, 14, 21 and a cross-section of an intermediate assembly 2 and an assembly 1 comprising two adjacent hollow parts. The method of forming the assembly according to the first embodiment (hereinafter, also referred to as a forming method according to the first embodiment) is a method of forming the assembly 1 in which the components 11 to 21 are integrated by using the core 101. As shown in FIG. 2, the forming process according to the first embodiment includes an assembling step (S101), a bagging step (S102), a heating step (S103), and a demolding step (S104).

In the first embodiment, for example, the assembly 1 is molded by the assembly molding system 100 shown in FIG. 2. As shown in FIG. 2, the assembly molding system 100 includes at least a core 101, a bag material 102 as a first bag material, a mold 103, a bag material 104 as a second bag material, a pressure control device 105, and a heating device 106.

Hereinafter, a specific description will be given with reference to FIG. 2. In the assembling step (S101), the core 101 is first covered with the bag material 102. The assembly molding system 100 has a number of cores 101 depending on the number of hollow portions of the assembly 1. The core 101 forms a hollow portion of the assembly 1 which is a molded article. The core 101 has a shape corresponding to the shape of the hollow portion to be molded. The core 101 has heat shrinkability. Thereby, the core 101 can be easily taken out from the inside of the assembly 1 in the demolding process.

The core 101 is formed of a material capable of holding the shape at the temperature and the atmospheric pressure in the assembling step and the bag process, and not melted by the heating in the heating process. The temperature in the assembling step and the bag process may be, for example, room temperature. The atmospheric pressure inside the bag material 102 encasing the core 101 in the assembling step and the bag process may be, for example, from 1 to 0 atmospheric pressure, i.e., from atmospheric pressure to vacuum.

The core 101 is formed of a material that shrinks by heating in the heating step. The core 101 has a heat shrinkability that shrinks at a temperature lower than or equal to a curing temperature of a matrix resin described later. Specifically, the core 101 is formed of a foamable material such as a foamed resin. The shrinkage coefficient of the heat shrinkage of the foamable material may be, for example, 5 to 95%, as long as the core 101 can be removed from the inside of the assembly 1 in the demolding process. As such a foamed resin, for example, polystyrene foam can be used. Since the core 101 formed of polystyrene foam can be manufactured at low cost, an increase in cost is suppressed.

The bag material 102 is made of a material having airtightness enough to maintain the pressure difference between the inside and the outside of the bag material 102 and having durability enough to not be damaged in the molding process of the assembly 1. For example, when the assembly 1 is formed of a material containing epoxy, the bag material 102 is formed of a material having a heat resistance of 130 to 220 degrees or more, which is a temperature at the time of heating. When the assembly 1 is formed of a material containing polyimide, the bag material 102 is formed of a material having heat resistance of 400 degrees or more, which is a temperature at the time of heating. Further, for example, the bag material 102 is made of a material having durability such that the pressure difference between the inside and the outside of the bag material 102 is not damaged even by a pressure difference in the range of 0.3 to 10 atmospheres. Specifically, the bag material 102 is made of a material having flexibility and excellent heat resistance, such as nylon or silicone rubber. The thickness of the bag material 102 may be, for example, 20 to 2000 μm.

Further, the bag material 102 is preferably made of a highly stretchable material. This prevents damage to the bag material 102 due to sticking. The bag material 102 preferably covers the core 101 in a wrinkled state. As a result, the bag material 102 can be prevented from being damaged due to the sticking, and the degassing property can be improved. The wrinkles of the bag material 102 may be formed at least in the heating step from the viewpoint of preventing damage due to sticking of the bag material 102, but may be formed in the assembly step before the heating step from the viewpoint of improving workability.

Subsequently, in the assembling step, the intermediate assembly 2 having a hollow shape in which the core 101 covered with the bag material 102 is installed is assembled. The intermediate assembly 2 is assembled into a predetermined shape by combining the components 11 to 21 before curing.

The components 11 to 21 are, for example, prepreg materials in which the reinforcing fibers are impregnated with a matrix resin in advance. As reinforcing fibers, organic fibers such as carbon fibers, metal fibers, ceramic fibers, or combinations thereof can be used. As the matrix resin, a thermosetting resin such as epoxy or polyimide can be used.

Then, the intermediate assembly 2 is installed in the mold 103 together with the core 101 covered with the bag material 102. The mold 103 includes, for example, a lower jig 103a, an upper jig 103b, a cowl plate 103c, and a dam 103d. As the material of the mold 103, a material such as metal or fiber-reinforced plastic can be used, and is selected depending on the temperature at the time of heating and the assembly 1 to be molded.

When the intermediate assembly 2 is installed in the mold 103, the intermediate assembly 2 is sandwiched from the vertical direction by the jig 103a, 103b together with the core 101 and the bag material 102 so as to sandwich the components 12, 13, and 14 from the widthwise direction of the intermediate assembly 2. In the intermediate assembly 2, the respective cowl plate 103c and the dam 103d are arranged.

Preferably, the assembling step comprises pressing the intermediate assembly 2 against a core 101 located inside the intermediate assembly 2. This facilitates positioning of the components 11 to 21 when installed in the mold 103.

Next, in the bagging process (S102), the mold 103 in which the intermediate assembly 2 is installed is covered with the bag material 104. The bag material 104 is formed of the same material as the bag material 102. In the bag process, since the mold 103 is covered with the bag material 104 from the outer surface side of the mold 103, the operation of covering the mold 103 with the bag material 104 is facilitated. When the mold 103 is covered with the bag material 104, a space between the bag material 104 and the jig 103a is sealed with a scalant 107.

Subsequently, in the bag process, the pressure of the outside of the bag material 102 and the inside of the bag material 104 is made lower than the atmospheric pressure of the outside of the bag material 104 and the atmospheric pressure of the inside of the bag material 102 by using the pressure control device 105.

The atmospheric pressure on the outside of the bag material 102 and the inside of the bag material 104 is lower than the atmospheric pressure on the outside of the bag material 104 and the atmospheric pressure on the inside of the bag material 102. As a result, pressure from the inside to the outside of the bag material 102 and pressure from the outside to the inside of the bag material 104 are applied to the bag material 102, the bag material 104, and the intermediate assembly 2.

Further, in the pressure control device 105, it is preferable that the atmospheric pressure of the outside of the bag material 102 and the inside of the bag material 104 is lowered to a predetermined atmospheric pressure or less close to the vacuum state or the vacuum state. The atmospheric pressure on the outside of the bag material 102 and the inside of the bag material 104 is lowered to a predetermined atmospheric pressure or less close to the vacuum state or the vacuum state. Thereby, the pressure from the inner side to the outer side of the bag material 102 and the pressure from the outer side to the inner side of the bag material 104 increase, respectively. As such, greater pressure is applied to the bag material 102, the bag material 104, and the intermediate assembly 2.

Next, in S103, the pressure control device 105 is used to lower the atmospheric pressure on the outside of the bag material 102 and the inside of the bag material 104 than the atmospheric pressure on the outside of the bag material 104 and the atmospheric pressure on the inside of the bag material 102. In this state, the intermediate assembly 2 is heated using the heating device 106.

In the heating step, the pressure control device 105 preferably sets the air pressure inside the bag material 102 higher than the air pressure outside the bag material 104. The pressure control device 105 increases the air pressure inside the bag material 102 by pressurizing the inside of the bag material 102, for example. That is, in the heating step, it is preferable that the pressure inside the bag material 102 is higher than the pressure outside the bag material 104, and the intermediate assembly 2 is heated. By making the pressure inside the bag material 102 higher than the pressure outside the bag material 104, the pressure from the inside to the outside of the bag material 102 increases, so that a stronger pressure is applied to the bag material 102, the bag material 104, and the intermediate assembly 2.

In addition, in the heating step, the heating device 106 heats the intermediate assembly 2 at 130 to 220 degrees when the matrix resin of the intermediate assembly 2 is epoxy. When the matrix resin of the intermediate assembly 2 is polyimide, the intermediate assembly 2 is heated at 400 degrees. As described above, in the heating step, the intermediate assembly 2 is cured by heating the uncured intermediate assembly 2 at a temperature equal to or higher than the curing temperature of the matrix resin. Then, in the heating step, the core 101 is contracted by the above-described heating.

Next, in the demolding step (S104), when the intermediate assembly 2 is cured, heating using the heating device 106 is stopped, and the temperature of the assembly 1 formed by heating is lowered to room temperature. Then, the bag material 104 is removed from the mold 103. Thereafter, the core 101 is removed from the inside of the assembly 1 together with the bag material 102, and the mold 103 is removed from the assembly 1. The core 101 and the bag material 102 are taken out from the inside of the assembly 1 to the outside of the assembly 1 through the through hole 22. In the demolding step, since the core 101 is contracted by the heating in the heating step, it is easy to take out the core 101 and the bag material 102 from the inside of the assembly 1.

When the core 101 and the bag material 102 are taken out from the inside of the assembly 1, the pressure inside the bag material 102 is preferably set to be lower than the outside air pressure by using the pressure control device 105 or the like. This allows the bag material 102 to be affixed to the core 101, making it easier to remove the core 101 and the bag material 102 from the assembly 1.

From the above S101, the assembly 1 in which the components 11 to 21 are integrated can be formed by S104 process.

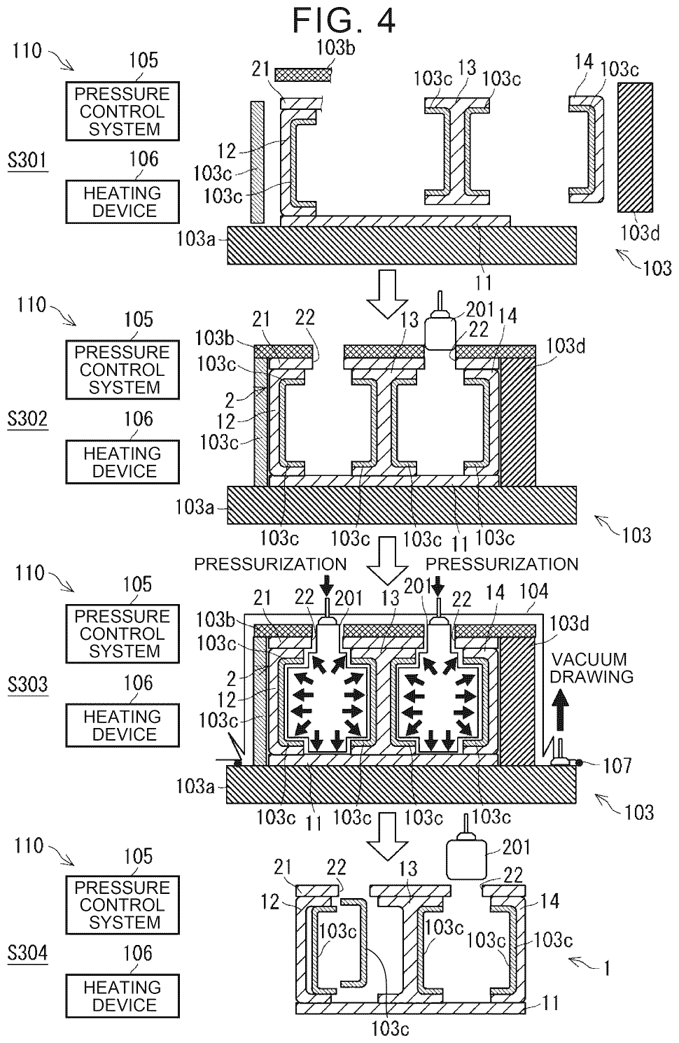

Here, FIG. 4 is a schematic cross-sectional view for explaining a molding method of the assembly according to Comparative Example 1. A method of forming the assembly according to Comparative Example 1 shown in FIG. 4 (hereinafter, also referred to as a forming method according to Comparative Example 1) is a method of forming the assembly 1 in which the components 11 to 21 are integrated by using the bladder bag 201.

As shown in FIG. 4, the forming process according to Comparative Example 1 includes an assembling step (S301), a bladder bag inserting step (S302), a bag and a heating step (S303), and a demolding step (S304). In Comparative Example 1, the assembly 1 is molded by the assembly molding system 110 shown in FIG. 4. As shown in FIG. 4, the assembly molding system 110 includes, for example, a bladder bag 201, a mold 103, a bag material 104, a pressure control device 105, and a heating device 106.

As shown in FIG. 4, in an assembling step (S301), a hollow-shaped intermediate assembly 2 is assembled. Then, the intermediate assembly 2 is installed in the mold 103. In the forming process according to Comparative Example 1, when the intermediate assembly 2 is installed in the mold 103, the intermediate assembly 2 is sandwiched from the vertical direction by the jig 103a, 103b so as to sandwich each of the components 12, 13, and 14 from the widthwise direction of the intermediate assembly 2. In the intermediate assembly 2, the cowl plates 103c and the dam 103d are arranged.

However, in the molding method according to Comparative Example 1, since there is no reference for positioning like the core 101, there is a possibility that the positioning of the components 11 to 21 becomes difficult.

Next, in a bladder bag inserting step (S302), a bladder bag 201 is inserted into the interior of the intermediate assembly 2 to form the hollows of the assembly 1. The bladder bag 201 is made of a material such as silicone rubber. The bladder bag 201 is inserted into the intermediate assembly 2 from the outside of the intermediate assembly 2 through the through hole 22. Accordingly, the bladder bag 201 is installed inside the intermediate assembly 2.

However, in the molding method according to Comparative Example 1, since the bladder bag 201 does not have a function of holding the shape of the inside of the intermediate assembly 2, it may be difficult to insert the bladder bag 201 into the inside of the intermediate assembly 2.

Next, in the bag and S303, first, the mold 103 on which the intermediate assembly 2 is installed is covered with the bag material 104. The pressure control device 105 is then used to lower the atmospheric pressure on the outside of the bladder bag 201 and the inside of the bag material 104 than the atmospheric pressure on the outside of the bag material 104 and the atmospheric pressure on the inside of the bladder bag 201. In this state, the intermediate assembly 2 is heated using the heating device 106.

Further, in the molding method according to Comparative Example 1, the inside of the bladder bag 201 is pressurized in order to make the air pressure inside the bladder bag 201 higher than the air pressure outside the bag material 104. However, when the bladder bag 201 inserted into the intermediate assembly 2 is stretched, the bladder bag 201 may rupture, for example, when the inside of the bladder bag 201 is pressurized. In this case, sufficient pressure is not applied to the intermediate assembly 2, and the resulting assembly 1 may become waste.

Next, in the demolding step (S304), when the intermediate assembly 2 is cured, the heating using the heating device 106 is stopped, and the temperature of the molded assembly 1 is lowered to room temperature. Then, the bag material 104 is removed from the mold 103. The bladder bag 201 is then removed from the interior of the assembly 1 and the mold 103 is removed from the assembly 1. The bladder bag 201 is removed from the inside of the assembly 1 to the outside of the assembly 1 through the through hole 22.

However, since it is difficult to remove the bladder bag 201 having a lower heat shrinkage than the core 101 from the inside of the assembly 1, the bladder bag 201 easily comes into contact with the assembly 1 in the process of removing the bladder bag 201. When the bladder bag 201 contacts the assembly 1, the expensive bladder bag 201 may be damaged.

As described above, in the molding method according to Comparative Example 1, since the bladder bag 201 is used, there is a problem that it is difficult to obtain the high-quality assembly 1 inexpensively and stably.

In order to solve such a problem, the molding method according to the first embodiment includes an assembly step and a bag step. In the assembling step, the intermediate assembly 2 having a hollow shape in which the core 101 covered with the bag material 102 is installed is assembled. In the bag process, the mold 103 in which the intermediate assembly 2 is installed together with the core 101 covered with the bag material 102 is covered with the bag material 104. Further, the molding method according to the first embodiment includes a heating step of heating the intermediate assembly 2 after the atmospheric pressure on the outside of the bag material 102 and the inside of the bag material 104 is lower than the atmospheric pressure on the outside of the bag material 104 and the atmospheric pressure on the inside of the bag material 102. The molding method according to the first embodiment includes a demolding step after the heating step. In the demolding process, after the bag material 104 is removed from the mold 103, the core 101 is removed from the inside of the molded assembly 1 by heating the intermediate assembly 2 together with the bag material 102, and demolding of the assembly 1 is performed. Further, the core 101 has heat shrinkability.

In the molding method according to the first embodiment, since the core 101 having heat shrinkability is used as a mold for molding the inside of the assembly 1, the core 101 can be easily taken out from the inside of the assembly 1 together with the bag material 102 in the demolding process. Therefore, according to the molding method of the first embodiment, the high-quality assembly 1 can be obtained inexpensively and stably as compared with the case where the bladder bag 201 is used as a mold for molding the inside of the assembly 1.

### Second Embodiment

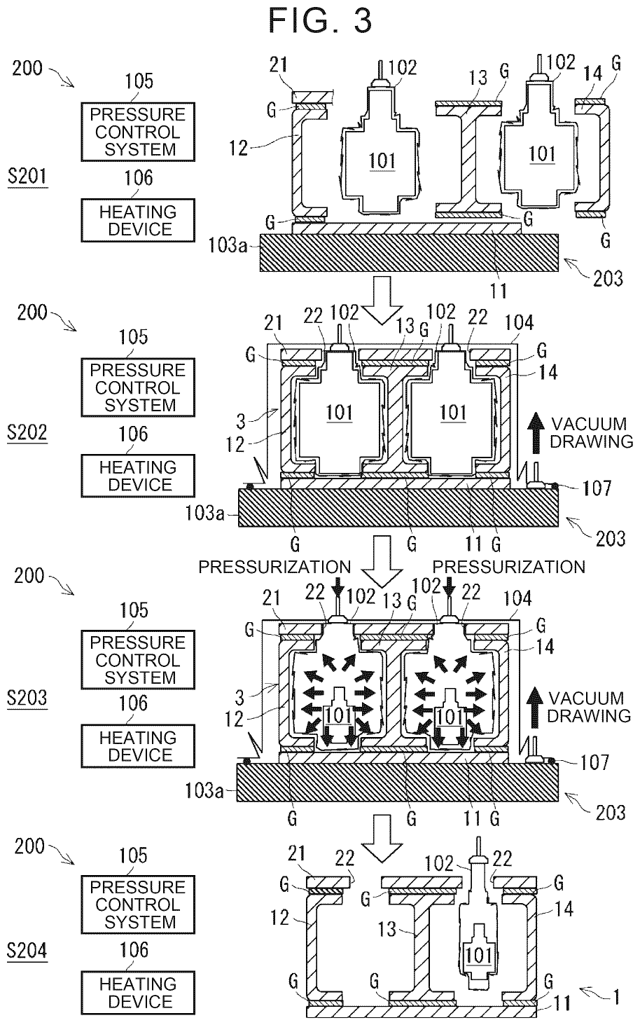

FIG. 3 is a schematic cross-sectional view for explaining a method of forming an assembly according to second embodiment. FIG. 3 shows a cross-section of a component 11, 12, 13, 14, 21 and a cross-section of an intermediate assembly 2 and an assembly 1 comprising two adjacent hollow parts. The method of forming the assembly according to the second embodiment (hereinafter, also referred to as a forming method according to the second embodiment) is a method of forming the assembly 1 in which the components 11 to 21 are bonded to each other using the core 101. As illustrated in FIG. 3, the forming process according to the second embodiment includes an assembling step (S201), a bagging step (S202), a heating step (S203), and a demolding step (S204).

In the second embodiment, for example, the assembly 1 is molded by the assembly molding system 200 shown in FIG. 3. As shown in FIG. 3, the assembly molding system 200 includes, for example, at least a core 101, a bag material 102, a mold 203, a bag material 104, a pressure control device 105, and a heating device 106.

Hereinafter, the differences from the molding method according to the first embodiment will be mainly described with reference to FIG. 3. In the assembling step (S201), the core 101 is first covered with the bag material 102. The assembly molding system 200 has a number of cores 101 depending on the number of hollow portions of the assembly 1. The core 101 has heat shrinkability that shrinks at a temperature lower than or equal to the curing temperature of the adhesive G described later. The bag material 102 preferably covers the core 101 in a wrinkled state. Thereafter, in the assembling step, the intermediate assembly 3 having a hollow shape in which the core 101 covered with the bag material 102 is installed is assembled. The intermediate assembly 3 is assembled into a predetermined shape by combining the components 11 to 21 after curing.

Then, the intermediate assembly 3 is installed in the mold 203 together with the core 101 covered with the bag material 102. The mold 203 has, for example, a lower jig 103a. When the intermediate assembly 3 is installed in the mold 203, the intermediate assembly 3 in which the adhesive G is interposed between the component 11 and the components 12 to 20 and between the component 21 and the components 12 to 20 is placed on the jig 103a. As the adhesive G, a thermosetting resin such as epoxy or polyimide can be used. Preferably, the assembling step comprises pressing the intermediate assembly 3 against a core 101 located inside the intermediate assembly 3.

Next, in the bag process (S202), the mold 203 in which the intermediate assembly 3 is installed is covered with the bag material 104. When the mold 203 is covered with the bag material 104, a space between the bag material 104 and the jig 103a is sealed with a sealant 107.

Subsequently, in the bag process, the pressure of the outside of the bag material 102 and the inside of the bag material 104 is made lower than the atmospheric pressure of the outside of the bag material 104 and the atmospheric pressure of the inside of the bag material 102 by using the pressure control device 105.

The atmospheric pressure on the outside of the bag material 102 and the inside of the bag material 104 is lower than the atmospheric pressure on the outside of the bag material 104 and the atmospheric pressure on the inside of the bag material 102. As a result, pressure from the inside to the outside of the bag material 102 and pressure from the outside to the inside of the bag material 104 are applied to the bag material 102, the bag material 104, and the intermediate assembly 3. Further, in the pressure control device 105, it is preferable that the atmospheric pressure of the outside of the bag material 102 and the inside of the bag material 104 is lowered to a predetermined atmospheric pressure or less close to the vacuum state or the vacuum state.

Next, in S203, the pressure control device 105 is used to lower the atmospheric pressure on the outside of the bag material 102 and the inside of the bag material 104 than the atmospheric pressure on the outside of the bag material 104 and the atmospheric pressure on the inside of the bag material 102. In this state, the intermediate assembly 3 is heated using the heating device 106. In the heating step, the pressure control device 105 preferably sets the air pressure inside the bag material 102 higher than the air pressure outside the bag material 104. The pressure control device 105 increases the air pressure inside the bag material 102 by pressurizing the inside of the bag material 102, for example. That is, in the heating step, it is preferable that the pressure inside the bag material 102 is higher than the pressure outside the bag material 104, and the intermediate assembly 3 is heated.

Further, in the heating step, when the adhesive G is epoxy, the heating device 106 heats the intermediate assembly 3 at 130 to 220 degrees, and when the adhesive G is polyimide, heats the intermediate assembly 3 at 400 degrees. In this way, in the heating step, by heating the intermediate assembly 3 at a temperature equal to or higher than the curing temperature of the adhesive G, the components 11 and 21 and the components 12 to 20 adhere to each other. Then, in the heating step, the core 101 is contracted by the above-described heating.

Next, in the demolding step (S204), when the adhesive G is cured, the heating using the heating device 106 is stopped, and the temperature of the assembly 1 formed by the heating is lowered to room temperature. Then, the bag material 104 is removed from the mold 203. Thereafter, the core 101 is removed from the inside of the assembly 1 together with the bag material 102, and the mold 203 is removed from the assembly 1. The core 101 and the bag material 102 are taken out from the inside of the assembly 1 to the outside of the assembly 1 through the through hole 22. In the demolding step, since the core 101 is contracted by the heating in the heating step, it is easy to take out the core 101 and the bag material 102 from the inside of the assembly 1. When the core 101 and the bag material 102 are taken out from the inside of the assembly 1, the pressure inside the bag material 102 is preferably set to be lower than the outside air pressure by using the pressure control device 105 or the like.

From the above S201, it is possible to form the assembly 1 in which the components 11 to 21 are bonded to each other by S204 process.

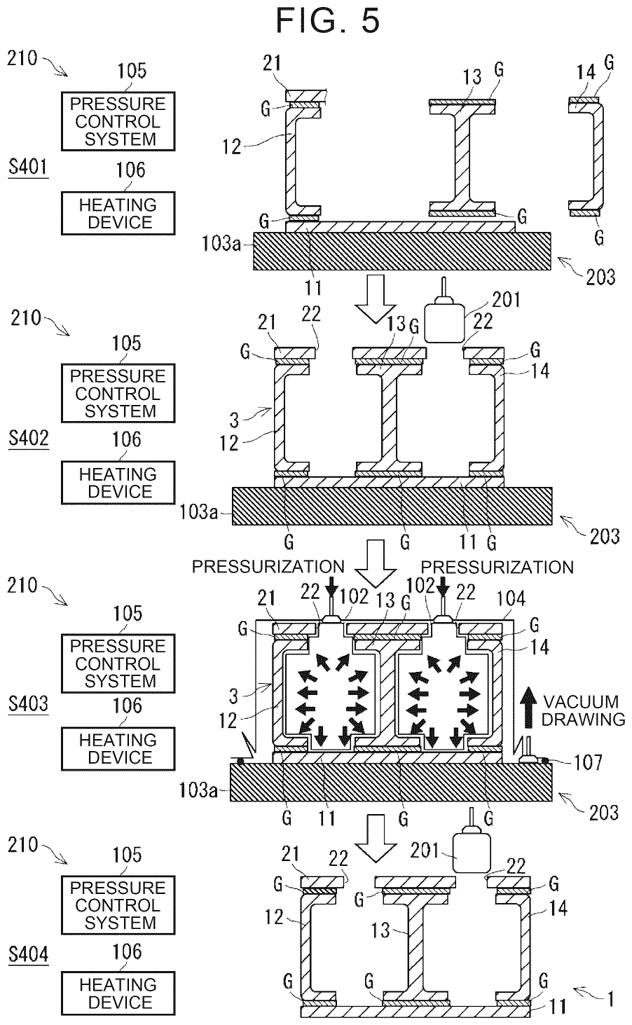

Here, FIG. 5 is a schematic cross-sectional view for explaining a molding method of the assembly according to Comparative Example 2. A molding method of the assembly according to Comparative Example 2 shown in FIG. 5 (hereinafter, also referred to as a molding method according to Comparative Example 2) is a method of molding the assembly 1 in which the components 11 to 21 are bonded to each other using the bladder bag 201.

As shown in FIG. 5, the forming process according to Comparative Example 2 includes an assembling step (S401), a bladder bag inserting step (S402), a bag and a heating step (S403), and a demolding step (S404). In Comparative Example 2, the assembly 1 is molded by the assembly molding system 210 shown in FIG. 5. As shown in FIG. 5, the assembly molding system 210 includes, for example, a bladder bag 201, a mold 203, a bag material 104, a pressure control device 105, and a heating device 106.

Hereinafter, the differences from the molding method according to the second embodiment will be mainly described with reference to FIG. 5. As shown in FIG. 5, in the assembling step (S401), the hollow-shaped intermediate assembly 3 is assembled. Then, the intermediate assembly 3 is installed in the mold 203. In the forming process according to Comparative Example 2, when the intermediate assembly 3 is installed in the mold 203, the intermediate assembly 3 in which the adhesive G is interposed between the component 11 and the components 12 to 20 and between the component 21 and the components 12 to 20 is placed on the jig 103a.

However, in the molding method according to Comparative Example 2, since there is no reference for positioning like the core 101, there is a possibility that the positioning of the components 11 to 21 becomes difficult.

Next, in a bladder bag inserting step (S402), a bladder bag 201 is inserted into the interior of the intermediate assembly 3 to form the hollows of the assembly 1. The bladder bag 201 is inserted into the intermediate assembly 3 from the outside of the intermediate assembly 3 through the through hole 22. As a result, the bladder bag 201 is installed inside the intermediate assembly 3.

However, in the molding method according to Comparative Example 2, since the bladder bag 201 does not have a function of holding the shape of the inside of the intermediate assembly 3, it may be difficult to insert the bladder bag 201 into the inside of the intermediate assembly 3.

Next, in the bag and S403, first, the mold 203 on which the intermediate assembly 3 is installed is covered with the bag material 104. The pressure control device 105 is then used to lower the atmospheric pressure on the outside of the bladder bag 201 and the inside of the bag material 104 than the atmospheric pressure on the outside of the bag material 104 and the atmospheric pressure on the inside of the bladder bag 201. In this state, the intermediate assembly 3 is heated using the heating device 106.

Further, in the molding method according to Comparative Example 2, the inside of the bladder bag 201 is pressurized in order to make the air pressure inside the bladder bag 201 higher than the air pressure outside the bag material 104. However, when the bladder bag 201 inserted into the intermediate assembly 3 is stretched, the bladder bag 201 may rupture, for example, when the inside of the bladder bag 201 is pressurized. In this case, sufficient pressure is not applied to the intermediate assembly 3, and the resulting assembly 1 may become waste.

Next, in the demolding step (S404), when the adhesive G is cured, the heating using the heating device 106 is stopped, and the temperature of the molded assembly 1 is lowered to room temperature. Then, the bag material 104 is removed from the mold 203. The bladder bag 201 is then removed from the interior of the assembly 1 and the mold 203 is removed from the assembly 1. The bladder bag 201 is removed from the inside of the assembly 1 to the outside of the assembly 1 through the through hole 22.

However, since it is difficult to remove the bladder bag 201 having a lower heat shrinkage than the core 101 from the inside of the assembly 1, the bladder bag 201 easily comes into contact with the assembly 1 in the process of removing the bladder bag 201. When the bladder bag 201 contacts the assembly 1, the expensive bladder bag 201 may be damaged.

As described above, in the molding method according to Comparative Example 2, since the bladder bag 201 is used in the same manner as the molding method according to Comparative Example 1, there is a problem that it is difficult to obtain the high-quality assembly 1 at low cost and stably.

In response to such a problem, the molding method according to the second embodiment includes an assembly step and a bag step. In the assembling step, the intermediate assembly 3 having a hollow shape in which the core 101 covered with the bag material 102 is installed is assembled. In the bag process, the mold 203 in which the intermediate assembly 3 is installed together with the core 101 covered with the bag material 102 is covered with the bag material 104. Further, the molding method according to the first embodiment includes a heating step of heating the intermediate assembly 3 after the atmospheric pressure on the outside of the bag material 102 and the inside of the bag material 104 is lower than the atmospheric pressure on the outside of the bag material 104 and the atmospheric pressure on the inside of the bag material 102. The molding method according to the first embodiment includes a demolding step after the heating step. In the demolding process, after the bag material 104 is removed from the mold 203, the core 101 is removed from the inside of the molded assembly 1 by heating the intermediate assembly 3 together with the bag material 102, and demolding of the assembly 1 is performed. Further, the core 101 has heat shrinkability.

In the molding method according to the second embodiment, since the core 101 having heat shrinkability is used as a mold for molding the inside of the assembly 1, the core 101 can be easily taken out from the inside of the assembly 1 together with the bag material 102 in the demolding process. Therefore, according to the molding method according to the second embodiment, as in the molding method according to the first embodiment, the high-quality assembly 1 can be obtained inexpensively and stably as compared with the case where the bladder bag 201 is used as a mold for molding the inside of the assembly 1.

The present disclosure is not limited to the above-described embodiments, and can be appropriately modified without departing from the scope of the present disclosure. For example, in Embodiments 1 and 2, the method of forming the assembly 1 has been described using the core 101 having heat shrinkability as an example, but the present disclosure is not limited thereto. For example, the core 101 may be crushable instead of being heat shrinkable. The crushability of the core 101 facilitates removal of the core 101 from the interior of the assembly 1 along with the bag material 102 during the demolding process. After crushing, the core 101 is taken out from the inside of the assembly 1 to the outside of the assembly 1 through the through hole 22.

The crushable core 101 is preferably formed by aggregating the granular material, and is crushed in the demolding step. As a result, the core 101 can be reused, and thus an increase in cost is suppressed. As the granular material, for example, polyimide, iron beads, sand, or the like can be used.

Further, in the second embodiment, the method of forming the assembly 1 has been described by taking a case where the components 11 to 21 are prepreg materials as an example, but the present disclosure is not limited thereto. For example, the components 11 to 21 may be metallic materials.

What is claimed is:

1. A method of forming an assembly, the method comprising:
assembling an intermediate assembly that is hollow and has a core covered with a first bag material installed inside the intermediate assembly;
covering a mold, in which the intermediate assembly is installed together with the core covered with the first bag material, with a second bag material;
heating the intermediate assembly after an air pressure outside the first bag material and inside the second bag material is made lower than an air pressure outside the second bag material and an air pressure inside the first bag material; and
demolding the assembly by removing the second bag material from the mold after the heating, and thereafter removing the core together with the first bag material from inside the assembly formed by heating the intermediate assembly, wherein the core is heat-shrinkable or crushable.

2. The method according to claim 1, wherein the first bag material covers the core in a wrinkled state.

3. The method according to claim 1, wherein the assembling includes pressing the intermediate assembly against the core installed inside the intermediate assembly.

4. The method according to claim 1, wherein the heating includes heating the intermediate assembly with the air pressure inside the first bag material made higher than the air pressure outside the second bag material.

5. The method according to claim 1, wherein the core is formed by aggregating a granular material, and is crushed in the demolding.
